(19) United States
(12) Patent Application Publication
(10) Pub. No.: US 2026/0277951 A1
(43) Pub. Date: Sep. 17, 2026

(54) ADAPTIVE ALIGNMENT TRANSFER FOR MACHINE LEARNING MODELS

(71) Applicant: INTUIT INC., Mountain View, CA (US)

(72) Inventors: Matan VETZLER, Tel Aviv (IL); Linoy COHEN, Tel Aviv (IL); Shai ARDAZI, Tel Aviv (IL); Lior Vassertail AZROEL, Tel Aviv (IL)

(73) Assignee: INTUIT INC., Mountain View, CA (US)

(21) Appl. No.: 19/082,013

(22) Filed: Mar. 17, 2025

(51) Int. Cl. G06F 16/3329; G06N 3/0475; G06N 3/082; G06N 20/00

(52) U.S. Cl. CPC G06F 16/33295; G06N 3/0475; G06N 3/082; G06N 20/00

(57) ABSTRACT

At least one processor may generate at least one modification for at least one weight of an unaligned target large language model (LLM). The generating may include obtaining at least one delta defining a difference between at least one layer of an unaligned source LLM and the at least one layer of an aligned source LLM and performing at least one mutation operation on the at least one delta. The at least one processor may inject the at least one modification into at least one target layer of the unaligned target LLM, thereby generating an aligned target LLM.

### BACKGROUND

Training large language models (LLMs) for specific use cases or preferences involves a multi-step process that is both expensive and time-consuming. To summarize the overall training process, pre-training lays the foundation for the model, fine-tuning adds task-specific knowledge, and alignment ensures the model adheres to desired preferences, such as tone, safety, or specificity. Each of these operations are computationally intensive, and known alignment techniques generally do not adapt to dynamic use cases without significant retraining. In other words, separate LLMs are individually aligned using the full expensive and time-consuming alignment training processing even if desired preferences are shared for the separate LLMs.

### BRIEF DESCRIPTION OF THE DRAWINGS

FIG. 1 shows an example adaptive alignment transfer system according to some embodiments of the disclosure.

FIG. 2 shows an example adaptive alignment transfer according to some embodiments of the disclosure.

FIG. 3 shows an example adaptive alignment transfer process according to some embodiments of the disclosure.

FIG. 4 shows an example computing device according to some embodiments of the disclosure.

### DETAILED DESCRIPTION OF SEVERAL EMBODIMENTS

Systems and methods described herein may provide adaptive alignment transfer (AAT), which can perform LLM alignment training with greatly reduced computational resources and significantly faster compared with legacy alignment training techniques. Current methods like reinforcement learning from human feedback (RLHF), direct preference optimization (DPO), and odds ratio preference optimization (ORPO) are computationally intensive and do not inherently adapt to dynamic use cases without significant retraining. The disclosed systems and methods can address the inefficiency and rigidity of existing alignment methodologies by introducing a more dynamic, adaptive, and resource-efficient approach. For example, embodiments described herein may integrate dynamic feedback loops and genetic algorithms to optimize model alignment training, making the alignment phase faster, saving hours of expensive hardware training, and allowing faster training cycles. This can include determining or obtaining a delta defining a difference between one or more pre-alignment and post-alignment source model layers and performing one or more mutations to modify the delta layer(s) for a target model’s alignment. The mutated layer(s) may be injected into the target model, thereby aligning the target model. Embodiments described herein may evolve and adapt alignment weights in real-time based on continuous feedback (e.g., from user interactions and/or performance metrics). By simulating evolutionary processes, systems and methods described herein may select, mutate, and/or recombine alignment strategies, converging on optimal solutions more efficiently than traditional methods. Disclosed embodiments can offer significant reductions in computational time and resource usage while maintaining high alignment quality.

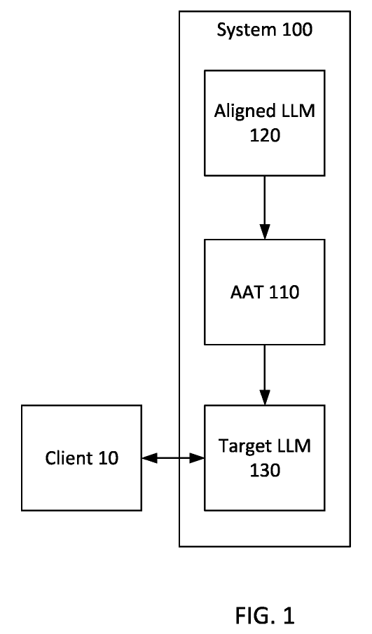

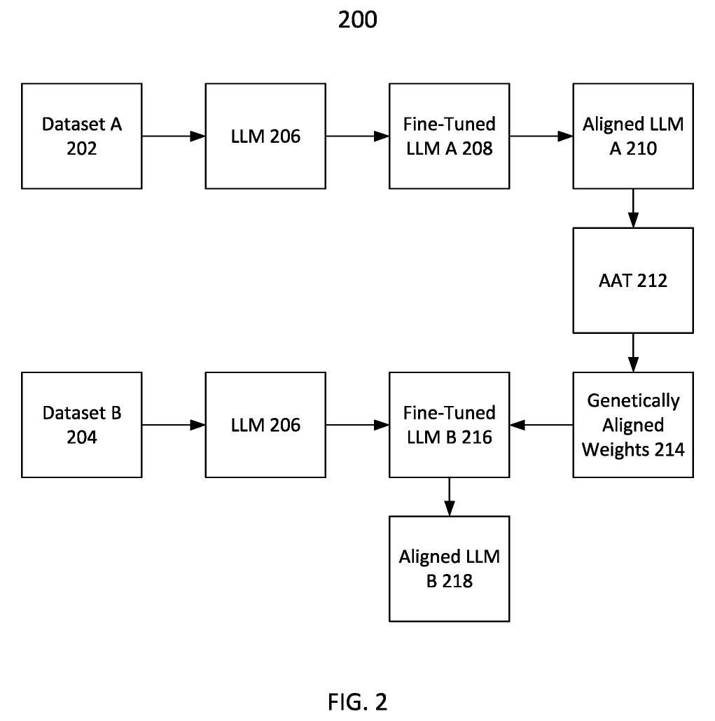

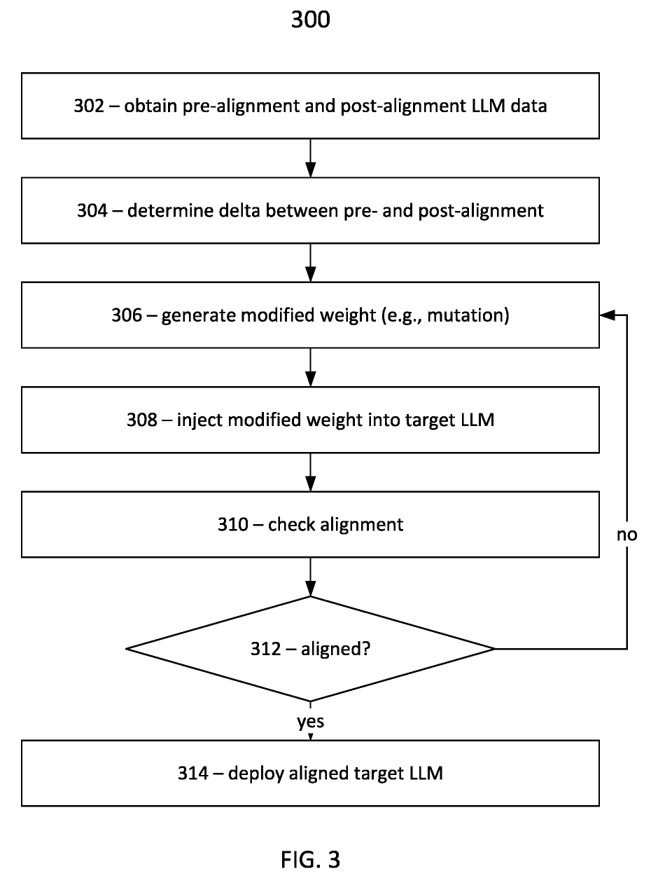

FIG. 1 shows an example AAT system 100 according to some embodiments of the disclosure. System 100 may include one or more modules, such as AAT module 110, and/or may include or be in communication with one or more LLMs such as aligned LLM 120 and target LLM 130. The elements of system 100 are described in greater detail below with respect to FIGS. 2-3, but in general, system 100 can perform AAT from aligned LLM 120 to target LLM 130, aligning target LLM 130 without performing alignment training on target LLM 130. Once aligned, target LLM 130 may be deployed, such that one or more clients 10 and/or other devices can send prompts to aligned target LLM 130 and receive replies from aligned target LLM 130.

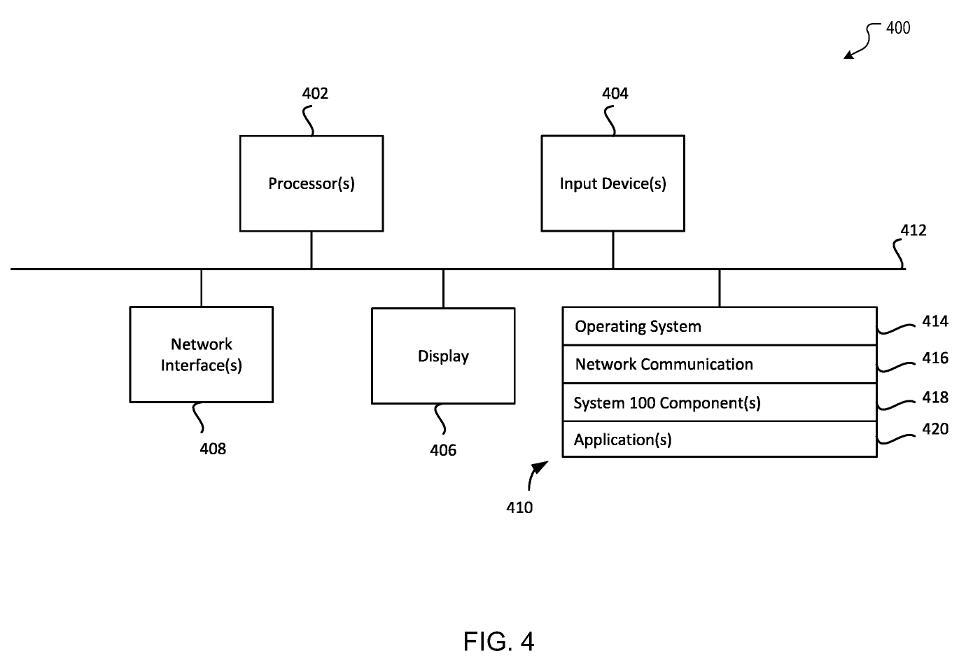

Illustrated components may include a variety of hardware, firmware, and/or software components that interact with one another. Some components shown in FIG. 1 may communicate with one another using networks. For example, system 100 may communicate with client 10 and, when aligned LLM 120 and/or target LLM 130 are not part of system 100, aligned LLM 120 and/or target LLM 130 through one or more networks (e.g., the Internet, an intranet, and/or one or more networks that provide a cloud environment). In some embodiments, elements of system 100 may communicate with one another through the one or more networks. Each component may be implemented by one or more computers (e.g., as described below with respect to FIG. 4).

Elements illustrated in FIG. 1 (e.g., system 100 (including AAT 110, aligned LLM 120, and target LLM 130) and client 10) are each depicted as single blocks for ease of illustration, but those of ordinary skill in the art will appreciate that these may be embodied in different forms for different implementations. For example, while separate modules of system 100 are depicted separately, any combination of these elements may be part of a combined hardware, firmware, and/or software element. Moreover, while the modules are depicted as parts of a single system 100 element, any combination of these elements may be distributed among multiple logical and/or physical locations. Also, while one client 10, one AAT 110, one aligned LLM 120, and one target LLM 130 are illustrated, this is for clarity only, and multiples of any of the above elements may be present. In practice, there may be single instances or multiples of any of the illustrated elements, and/or these elements may be combined or co-located. For example, a plurality of clients 10 may send prompts to target LLM 130 and/or aligned LLM 120. In another example, system 100 may use AAT 110 to align multiple target LLMs 130.

In the following descriptions of how the illustrated components function, several examples are presented. However, those of ordinary skill in the art will appreciate that these examples are merely for illustration, and the disclosed embodiments are extendable to other application and data contexts.

FIG. 2 shows an example adaptive alignment transfer 200 according to some embodiments of the disclosure. The adaptive alignment transfer may involve two instances of LLM 206, where each LLM 206 has the same architecture. For example, each LLM 206 may have the same layer structures, embeddings, transformer architectures, parameters, and/or other fundamental elements prior to training and/or tuning. A goal of adaptive alignment transfer 200 may be to produce aligned LLM A 210 and aligned LLM B 218 tuned for different purposes, but aligned according to the same alignment considerations.

Separate from alignment, each LLM 206 may be individually fine-tuned using data of interest using a supervised fine-tuning (SFT) process or other process. For example, system 100 may train one instance of LLM 206 on dataset A 202 to produce fine-tuned LLM A 208 and may train the other instance of LLM 206 on dataset B 204 to produce fine-tuned LLM B 216. As an illustrative, but not necessarily limiting, example, dataset A 202 may include data related to tax topics, and dataset B 204 may include data related to accounting topics. Accordingly, the training may produce fine-tuned LLM A 208 configured to function as a tax software help chatbot, and the training may produce fine-tuned LLM B 216 configured to function as an accounting software help chatbot.

The fine-tuned LLMs may have different functions, but they may both require alignment for safety, security, voice and tone, coherence, and/or other considerations that are not specific to a given topic. Such considerations may be common to all chatbots provided by a provider of both tax and accounting software products, for example.

To align both LLMs, system 100 may apply one or more alignment techniques to one of the LLMs (in this example, fine-tuned LLM A 208). For example, system 100 may align fine-tuned LLM A 208 using RLHF, DPO, ORPO, and/or any other alignment technique to create an initial set of alignment weights. The initial set of alignment weights may correctly align fine-tuned LLM A 208. However, because fine-tuned LLM A 208 and fine-tuned LLM B 216 have been trained on different data, the initial set of alignment weights may not align fine-tuned LLM B 216 as effectively as fine-tuned LLM A 208.

To compensate for this issue without performing a full alignment process using the one or more alignment techniques on fine-tuned LLM B 216, system 100 may perform AAT 212 to produce genetically aligned weights 214. An example AAT 212 process is described in detail below with respect to FIG. 3, but essentially AAT 212 can iterate through several generations of modifications to the initial set of alignment weights to produce genetically aligned weights 214 that align fine-tuned LLM B 216 precisely without requiring full, computationally costly alignment of fine-tuned LLM B 216. System 100 can inject genetically aligned weights 214 by replacing and/or merging weights already present in fine-tuned LLM B 216 by genetically aligned weights 214. As a result, system 100 can produce aligned LLM B 218 without using RLHF, DPO, ORPO, and/or any other alignment technique on fine-tuned LLM B 216.

FIG. 3 shows an example AAT process 300 according to some embodiments of the disclosure. System 100 may perform process 300 to align an LLM starting from alignment weights of a previously-aligned LLM. Process 300 may begin with an aligned source LLM and a fine-tuned, but not aligned, target LLM.

At 302, system 100 may obtain pre-alignment and post-alignment data for a source LLM. For example, the data may include at least one pre-alignment weight of at least one source layer of the source LLM and at least one post-alignment weight of the at least one source layer of the source LLM. As noted above, the source LLM may have been aligned using one or more chosen alignment technique(s) (e.g., RLHF, DPO, ORPO), creating an initial set of alignment weights for some specific need, like safety, voice and tone, coherence, etc.

At 304, system 100 may determine at least one delta between the at least one pre-alignment weight and the at least one post-alignment weight obtained at 302. In other words, the at least one delta may define a difference between at least one layer of an unaligned source LLM and the at least one layer of an aligned source LLM. To obtain the at least one delta, system 100 may subtract at least one first matrix indicating at least one weight of the unaligned source LLM from at least one second matrix indicating at least one weight of the aligned source LLM (or subtract the at least one second matrix from the at least one first matrix). This matrix subtraction operation may produce at least one third matrix.

For example, consider a source LLM having ten layers, which is presented for illustration only and is not intended to limit the configuration of any source LLM with which method 300 is used. Each pre-alignment layer of the source LLM may have a matrix of weights, providing ten first matrices. Each post-alignment layer of the source LLM may have a matrix of weights, providing ten second matrices. By subtracting the second matrix of each layer from the first matrix of the same layer, system 100 may obtain ten matrices of delta values.

At 306, system 100 may generate at least one modified weight using the at least one delta determined at 304. For example, system 100 may perform at least one mutation operation on the at least one delta, such as one or more of a Gaussian noise mutation, a swap mutation, and a scaling mutation.

Returning to the ten layer source LLM example, system 100 may modify one or more elements within the ten matrices of delta values generated at 304. System 100 may perform one or more mutation operations on the elements within the matrices of delta values, thereby introducing random or pseudorandom changes to the delta values to explore new regions of the solution space. Mutations may include Gaussian noise, where system 100 adds a small random noise to a weight value, swap mutation, where system 100 exchanges weights between two random positions in a matrix, and/or scaling mutation, where system 100 multiplies a random subset of weights by a factor near 1 (e.g., 0.9-1.1).

System 100 may apply the one or more mutation operations, such as the examples above, thereby producing the at least one modified weight. In the ongoing example, this results in ten matrices of modified weights.

At 308, system 100 may inject the at least one modified weight from 306 into at least one target layer of a target LLM, thereby generating an aligned target LLM. The target layer may include at least one fourth matrix, and the injection may include matrix addition of the at least one third matrix to the at least one fourth matrix. For example, in the case where the at least one modified weight is a set of matrices, system 100 may perform matrix addition to add the modified weight matrices to the respective weight matrices of the target LLM.

At 310, system 100 may check the alignment of the target LLM after injection at 308. For example, system 100 can test alignment of the target LLM and obtain an alignment score. In some embodiments, the testing and scoring can include prompting the target LLM with one or more questions from a safety dataset. For example, these questions can be written to elicit unsafe answers from an improperly aligned LLM, such as answers showing racial or other bias, information about how to commit crimes, and/or other information that may be illegal, unsafe, and/or damaging to the reputation of an organization or entity providing access to the LLM. System 100 can score answers generated by the target LLM. Scoring can be binary (e.g., “safe” or “unsafe”) in some embodiments. System 100 may score answers based on the presence or absence of keywords in some embodiments. In other embodiments, system 100 may provide the answers to a separate LLM and prompt the separate LLM to call out any unsafe content. By providing multiple questions and receiving and scoring multiple answers, system 100 may generate an overall score for the target LLM (e.g., by averaging, summing, or otherwise accounting for the individual answer scores together).

At 312, system 100 may determine whether the alignment score determined at 310 indicates acceptable alignment of the target LLM. For example, system 100 may compare the alignment score against a threshold value. In some cases, system 100 may determine that the alignment score is below a threshold and, in response to the determining that the alignment score is below the threshold, may repeat processing at 306-312. For example, system 100 may generate at least one second modified weight, which may including performing at least one mutation operation on the at least one modified weight as described above, and inject the at least one second modified weight into the at least one target layer of the aligned target LLM as described above. Each time mutation is repeated at 306, the specific changes applied to the weights may differ as a function of different random selections being made.

In some embodiments, when an iteration of mutation at 306, injection at 308, and scoring at 310 produces a lower score than a previous iteration, system 100 may revert to using the previous iteration’s mutations before performing another iteration. On the other hand, when an iteration of mutation at 306, injection at 308, and scoring at 310 produces a higher score than a previous iteration, system 100 may preserve the current iteration’s mutations before performing another iteration, even if the threshold is not reached.

System 100 may perform multiple iterations of processing at 306-312. In some cases, system 100 may iterate processing at 306-312 until the threshold is met or exceeded. In some cases, system 100 may iterate processing at 306-312 until the score does not improve beyond a predetermined improvement threshold (e.g., if after x iterations, the score does not improve by at least y points, stop).

At 314, after the score surpasses the threshold or iterations of processing at 306-312 are otherwise completed, system 100 may deploy the aligned target LLM. For example, the aligned target LLM (e.g., target LLM 130) may be placed into production and may process prompts received from client 10.

After process 300, target LLM 130 may be both fine-tuned for a given use case and aligned for safety or other concerns. However, unlike other alignment techniques, the disclosed systems and methods can align target LLM 130 without performing computationally expensive alignment training. Alignment according to process 300 takes a fraction of the time of other techniques, even with multiple iterations of processing at 306-312, and does not require graphics processing units (GPU)s and/or other expensive hardware.

In some embodiments, system 100 may obtain feedback from users of clients 10 as they interact with target LLM 130. For example, system 100 may collect real-time user interactions and performance feedback during model deployment. Based on this feedback, system 100 can adjust thresholds and/or safety dataset content and process target LLM 130 through processing at 306-312 again with the updated thresholds and/or safety dataset content to ensure that the alignment reflects current user preferences and performance goals accurately.

The following experiment is an example demonstrating the effectiveness of the above-described process 300. A vanilla LLama3.1 8B model was tested on a safety and performance benchmark, scoring 8.12 out of 10. After SFT training on a labeled dataset in the financial domain, the model saw a slight degradation in safety, scoring 7.85 out of 10. Initially applying an alignment method (DPO) using a safety preference dataset raised the score to 8.37 out of 10. The DPO-aligned model provided a comparison against the disclosed process 300.

The same model after SFT training but without DPO alignment was also aligned using process 300. Through successive generations of genetic operations, the fitness score improved iteratively. After 50 generations, the resulting vanilla model aligned from scratch reached a score of 8.22 out of 10. Continuous real-time feedback allowed the system to adapt, further enhancing this model's score to 8.51 out of 10 over a week of user interaction. These results indicate that AAT can efficiently optimize alignment with minimal retraining, adapting dynamically to changing user needs and improving performance over time, while being significantly faster then re-applying the alignment phase.

FIG. 4 shows a computing device 400 according to some embodiments of the disclosure. For example, computing device 400 may function as system 100 and/or any portion(s) thereof, or multiple computing devices 400 may function as system 100 and/or any portion(s) thereof.

Computing device 400 may be implemented on any electronic device that runs software applications derived from compiled instructions, including without limitation personal computers, servers, smart phones, media players, electronic tablets, game consoles, email devices, etc. In some implementations, computing device 400 may include one or more processors 402, one or more input devices 404, one or more display devices 406, one or more network interfaces 408, and one or more computer-readable mediums 410. Each of these components may be coupled by bus 412, and in some embodiments, these components may be distributed among multiple physical locations and coupled by a network.

Display device 406 may be any known display technology, including but not limited to display devices using Liquid Crystal Display (LCD) or Light Emitting Diode (LED) technology. Processor(s) 402 may use any known processor technology, including but not limited to graphics processors and multi-core processors. Input device 404 may be any known input device technology, including but not limited to a keyboard (including a virtual keyboard), mouse, track ball, and touch-sensitive pad or display. Bus 412 may be any known internal or external bus technology, including but not limited to ISA, EISA, PCI, PCI Express, NuBus, USB, Serial ATA or FireWire. In some embodiments, some or all devices shown as coupled by bus 412 may not be coupled to one another by a physical bus, but by a network connection, for example. Computer-readable medium 410 may be any medium that participates in providing instructions to processor(s) 402 for execution, including without limitation, non-volatile storage media (e.g., optical disks, magnetic disks, flash drives, etc.), or volatile media (e.g., SDRAM, ROM, etc.).

Computer-readable medium 410 may include various instructions 414 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 404; sending output to display device 406; keeping track of files and directories on computer-readable medium 410; controlling peripheral devices (e.g., disk drives, printers, etc.) which can be controlled directly or through an I/O controller; and managing traffic on bus 412. Network communications instructions 416 may establish and maintain network connections (e.g., software for implementing communication protocols, such as TCP/IP, HTTP, Ethernet, telephony, etc.).

System 100 components 418 may include instructions for performing the processing described herein. For example, system 100 components 418 may provide instructions for performing process 300 and/or other processing as described above. Application(s) 420 may be an application that uses or implements the outcome of processes described herein and/or other processes. In some embodiments, the various processes may also be implemented in operating system 414.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language "means for" or "step for" be interpreted under 35 U.S.C. 112(f). Claims that do not expressly include the phrase "means for" or "step for" are not to be interpreted under 35 U.S.C. 112(f).

What is claimed is:

1. A method comprising:
obtaining, by at least one processor, at least one pre-alignment weight of at least one source layer of a source large language model (LLM) and at least one post-alignment weight of the at least one source layer of the source LLM;
determining, by the at least one processor, at least one delta between the at least one pre-alignment weight and the at least one post-alignment weight;
generating, by the at least one processor, at least one modified weight, the generating comprising performing at least one mutation operation on the at least one delta; and
injecting, by the at least one processor, the at least one modified weight into at least one target layer of a target LLM, thereby generating an aligned target LLM.

2. The method of claim 1, wherein:
the at least one pre-alignment weight comprises at least one first matrix;
the at least one post-alignment weight comprises at least one second matrix; and
the determining comprises subtracting the at least one first matrix from the at least one second matrix or subtracting the at least one second matrix from the at least one first matrix to obtain the at least one modified weight.

3. The method of claim 2, wherein:
the at least one modified weight comprises at least one third matrix;
the at least one target layer comprises at least one fourth matrix; and
the injecting comprises adding the at least one third matrix to the at least one fourth matrix.

4. The method of claim 1, wherein the at least one mutation operation comprises at least one of a Gaussian noise mutation, a swap mutation, and a scaling mutation.

5. The method of claim 1, further comprising testing, by the at least one processor, an alignment of the aligned target LLM and thereby obtaining an alignment score.

6. The method of claim 5, further comprising:
determining, by the at least one processor, that the alignment score is below a threshold; and
in response to the determining that the alignment score is below the threshold:
generating, by the at least one processor, at least one second modified weight, the generating comprising performing at least one mutation operation on the at least one modified weight; and
injecting, by the at least one processor, the at least one second modified weight into the at least one target layer of the aligned target LLM.

7. The method of claim 1, further comprising processing, by the aligned target LLM, at least one prompt.

8. A method comprising:
generating, by at least one processor, at least one modification for at least one weight of an unaligned target large language model (LLM), the generating comprising:
obtaining at least one delta defining a difference between at least one layer of an unaligned source LLM and the at least one layer of an aligned source LLM, and
performing at least one mutation operation on the at least one delta;
injecting, by the at least one processor, the at least one modification into at least one target layer of the unaligned target LLM, thereby generating an aligned target LLM; and
processing at least one prompt by the aligned target LLM.

9. The method of claim 8, further comprising determining, by the at least one processor, the at least one delta by subtracting at least one first matrix indicating at least one weight of the unaligned source LLM from at least one second matrix indicating at least one weight of the aligned source LLM or subtracting the at least one second matrix from the at least one first matrix.

10. The method of claim 9, wherein:
the at least one modification comprises at least one third matrix;
the at least one target layer comprises at least one fourth matrix; and
the injecting comprises adding the at least one third matrix to the at least one fourth matrix.

11. The method of claim 9, wherein the at least one mutation operation comprises at least one of a Gaussian noise mutation, a swap mutation, and a scaling mutation.

12. The method of claim 9, further comprising testing, by the at least one processor, an alignment of the aligned target LLM and thereby obtaining an alignment score.

13. The method of claim 12, further comprising:
determining, by the at least one processor, that the alignment score is below a threshold; and
in response to the determining that the alignment score is below the threshold:
generating, by the at least one processor, at least one second modification, the generating comprising performing at least one mutation operation on the at least one modification, and
injecting, by the at least one processor, the at least one second modification into the at least one target layer of the aligned target LLM.

14. A system comprising:
at least one processor; and
at least one non-transitory computer-readable medium storing instructions that, when executed by the at least one processor, cause the at least one processor to perform processing comprising:
obtaining at least one pre-alignment weight of at least one source layer of a source large language model (LLM) and at least one post-alignment weight of the at least one source layer of the source LLM;
determining at least one delta between the at least one pre-alignment weight and the at least one post-alignment weight;
generating at least one modified weight, the generating comprising performing at least one mutation operation on the at least one delta; and
injecting the at least one modified weight into at least one target layer of a target LLM, thereby generating an aligned target LLM.

15. The system of claim 14, wherein:
the at least one pre-alignment weight comprises at least one first matrix;
the at least one post-alignment weight comprises at least one second matrix; and
the determining comprises subtracting the at least one first matrix from the at least one second matrix or subtracting the at least one second matrix from the at least one first matrix to obtain the at least one modified weight.

16. The system of claim 15, wherein:
the at least one modified weight comprises at least one third matrix;
the at least one target layer comprises at least one fourth matrix; and
the injecting comprises adding the at least one third matrix to the at least one fourth matrix.

17. The system of claim 14, wherein the at least one mutation operation comprises at least one of a Gaussian noise mutation, a swap mutation, and a scaling mutation.

18. The system of claim 14, wherein the processing further comprises testing an alignment of the aligned target LLM and thereby obtaining an alignment score.

19. The system of claim 18, wherein the processing further comprises:
determining that the alignment score is below a threshold; and
in response to the determining that the alignment score is below the threshold:
generating at least one second modified weight, the generating comprising performing at least one mutation operation on the at least one modified weight; and
injecting the at least one second modified weight into the at least one target layer of the aligned target LLM.

20. The system of claim 14, wherein the processing further comprises processing, by the aligned target LLM, at least one prompt.
